(19) United States
(12) Patent Application Publication
(10) Pub. No.: US 2012/0259635 A1
(43) Pub. Date: Oct. 11, 2012

(54) Document Certification and Security System

(76) Inventors: Gregory J. Ekchian, Belmont, MA (US); Jack A. Ekchian, Belmont, MA (US)

(21) Appl. No.: 13/440,389

(22) Filed: Apr. 5, 2012

Related U.S. Application Data
(60) Provisional application No. 61/516,588, filed on Apr. 5, 2011.
(60) Provisional application No. 61/571,890, filed on Jul. 6, 2011.

(51) Int. Cl. G10L 15/26; G06F 15/173; G10L 17/00; G06F 17/30

(52) U.S. Cl. 704/235; 707/781; 709/224; 704/246; 707/E17.005; 704/E17.001; 704/E15.043

(57) ABSTRACT

A system for the storing of client information in an independent repository is disclosed. Client data may be uploaded by client or those authorized by client or collected and stored by the repository. Data about the client file such as, for example, the time of upload and modifications are stored in a metadata file associated with the client file.

### CROSS-REFERENCE TO RELATED APPLICATIONS

This application claims priority of U.S. Provisional Patent Application No. 61/516,588, filed Apr. 5, 2011, entitled “Network Based Document Certification System” and U.S. Provisional Patent Application No. 61/571,890, filed, Jul. 6, 2011, entitled “Document Security and Certification System”, the contents of both of which are hereby incorporated herein by reference in their entirety.

### FIELD OF THE INVENTION

This invention pertains to the storage of certain information at a limited access repository at the request and direction of an independent client of the repository. Data about certain aspects and attributes of the information, such as for example, its genesis and evolution, may be tracked and recorded by the repository and stored as metadata that is associated with the client information. The client information may be supplied to the repository by the client, parties associated with or independent of the client or collected by the repository on behalf of or at the behest of the client. A client may elect to use the repository to store information for various reasons. For example, so that the client may depend on the repository to certify that the client was in possession of certain information as of a certain date. Client may also, for example, elect to store information so that it may be forwarded by the repository to one or more recipients on behalf of the client such that the repository operator could subsequently certify, for example, what information was forwarded to whom and when. The client may elect to manipulate the client information or allow others to view or manipulate the information. The metadata may include data, such as for example, the date and time and by whom the information was created or submitted to the repository, the date and time and from where the information was collected or received by the repository, by whom, how and when the information was altered, by whom and for how long the information was viewed. Preferably the metadata may not be altered by the client although the client may be given the opportunity to add comments clarifying various entries in the metadata.

### BACKGROUND OF INVENTION

Frequently, parties and individuals involved in commerce or personal or official business need to exchange important documents or other information using the postal service or various package delivery services. Frequently, documents need to be exchanged between parties where there exists at least the potential of an adversarial relationship. On occasion, one party may require proof that certain documents were sent and received by another party. Examples of such documents include various types of notices such as from a tenant to a landlord terminating a lease, recommendations from a stockbroker or investment advisor to a client, a demand for payment from a contractor to a customer, a complaint from a parent to a child's school, or a demand for performance during a contractual dispute.

In addition to written or printed material, documents may include, for example, digital or analog media, audio or video tapes and media, CDs or DVDs, hard drives, thumb-drives, etc. Documents may comprise, for example, pictures or video of a damaged car or precious artifacts sent to an insurance company before repairs are undertaken.

Various public or private traceable package delivery services are used extensively when proof of package delivery is necessary or desired. Such services include Registered or Certified Mail by the US Postal Service. In fact, during the first quarter of 2010, the United States Postal Service made a total of more than 63,000,000 Certified Mail and 679,000 Registered Mail deliveries and generated more than 48,000,000 Proof of Delivery Receipts.

Such services are also used to document the on-time delivery of time sensitive materials such as reports, applications, proposals, and business plans. In other situations, for example, professionals such as graphic artists, songwriters, designers, and playwrights rely on such services to document the delivery of confidential or proprietary information such as, for example, the design of a new corporate logo, a new evening gown, the design of a novel perfume bottle, the lyrics for a new song, or a manuscript for a new play to potential clients, investors or other interested individuals.

Relying on services such as the postal service or other package delivery services is frequently cumbersome and time-consuming compared to communicating on the internet. Also, these traditional services can only establish that a package was sent by a sender and that the package was received by a recipient. It is not possible to document or conclusively certify what was actually sent and what was received. Sometimes, especially when what is being sent is very voluminous, the sender may overlook something that needed to be included in a particular shipment or inadvertently include something that was not meant to be sent. On the other hand, the recipient may overlook items that were actually included in a received package. Such mistakes can lead to unnecessary disputes. Unfortunately, once sent, the sender of such a package cannot check or prove what was actually in the package and the recipient cannot necessarily check or prove what was or was not actually received.

Sometimes it is also desirable to document the development timeline and history of various types of intellectual property or trade secrets including manuscripts, patents, business plans, musical scores, lyrics, and various devices, materials and architectural designs. Corporations or individuals are frequently accused of stealing or misappropriating the inventions, plans, designs or ideas submitted to them for consideration. To defend against such accusations, many organizations frequently refuse to accept ideas or concepts from outside the organization. This frequently slows or renders untenable the efficient exchange of ideas among individuals and organizations to the possible detriment of all involved.

To guard against having their intellectual property or work product stolen or misappropriated, professionals frequently send documents to themselves by, for example, Certified or Registered mail so that, in the event of a dispute, they may be able to demonstrate that they were in possession of a concept or design at least as of the date of mailing. However, this is cumbersome because, for example, it is impossible to review or demonstrate what is in such a package without opening it and it is not possible to update the contents as development proceeds.

Alternatively, organizations and individuals resort to asking witnesses to occasionally examine documents and sign and date them to establish, for example, the chronology of development or the time of invention. Unfortunately, this approach requires that information, that ostensibly needs to be kept secret, be disclosed to a witness so that its existence and history can subsequently be certifiably documented. Also trustworthy and qualified witnesses, who can comprehend the substance of such disclosures, may not be conveniently available when needed. Such documentation is also susceptible to being tampered with after it is signed and, therefore, its authenticity can be challenged. In addition, a witness cannot conveniently sign a CD, DVD, other recordings, and digital and analog media.

Fax machines and, more recently, computer networks, such as the internet, are used extensively for the rapid exchange of information including, for example, various documents, emails and other electronic files containing various types of data among various entities worldwide. The transfer of various types of electronic communication, including, for example, faxes, emails, text messages, instant messages, voice messages, and digital/analog media over networks including the internet, can occur much more rapidly than is possible with conventional mail or package services. Networks such as the internet also facilitate the storage of vast quantities of electronic data at remote locations. US patent applications 2006/0031309; 2006/0031315; 2006/0064581; 2009/0248811 and 2010/0088765 and U.S. Pat. Nos. 6,438,583 and 7,647,321, the contents of all of which are incorporated herein by reference in their entirety, disclose methods for the transmission of electronic information using networks such as the internet. U.S. Pat. Nos. 5,473,776; 5,901,228; 6,952,724; 7,401,194; 7,685,096; 7,693,814; 7,831,662; and 7,844,573; and US Patent Applications 2003/0014433, 2009/0210427, and 2010/0324945, the contents of all of which are incorporated herein by reference in their entirety, describe systems for storing electronic data at a remote location by means of networks such as the internet. U.S. Pat. Nos. 5,444,782; 5,940,507; 6,985,719; 7,412;462; 7,774,618; 7,222,233, the contents of all of which are incorporated herein by reference in their entirety, describe the use of encryption to protect electronic data exchanged using networks. U.S. Pat. Nos. 6,978,380 and 7,639,806 and US patent application 2010/0333081, the contents of all of which are incorporated herein by reference in their entirety, disclose the identification and authentication of users of networks. However, while the speed and convenience with which information can be transferred over networks are major advantages, electronic files can be manipulated and altered by whoever is in control of the computer system where such files reside for any length of time. It may be difficult to prove that such manipulation has not occurred. For example, electronic files are frequently stored and manipulated on systems that can exchange files with other systems over the internet. Any electronic file that is created, sent or received can be altered by anyone who controls the system where such files reside for any period. Therefore, the authenticity of electronic information, such as, for example, data files, test results, emails and text messages, and how or when they are generated, sent or received cannot be readily proven. Therefore, data such as, for example, the time of creation, modification and source of files stored electronically may be challenged in an adversarial venue. Furthermore, it is very difficult for the sender of electronic information to prove where and even if a particular document was indeed delivered to an alleged recipient.

Electronic data, especially if it is stored on a network accessible system, is also susceptible to, for example, hacking and other forms of illicit access. Frequently, highly sensitive private information such as medical records and financial records are at risk. When information such as the names, addresses, bank account numbers, and social security information are stolen or lost from company computer systems as a result of online hacking, employee theft or carelessness, significant financial loss or liability can result. Both companies and individuals are susceptible to theft of this type of information.

### SUMMARY OF THE INVENTION

It is an object of this invention to provide an independent, limited access, network accessible, electronic data storage facility or repository for the storage of information on behalf of a client in a controlled environment. An independent repository preferably is one whose operator does not have a significant financial or other interest in the content of files stored in the repository or in the actions of the client, except to meet its obligation to store and protect the information and be compensated for these services. The client preferably retains control of the content and disposition of said information. But a record of some or preferably all of client actions and those of others, who are authorized to access the client information in storing or manipulating the stored information including, for example, uploading, downloading, transmitting, publishing, viewing, editing, or otherwise altering said content, is independently and verifiably obtained and retained by the operator of the repository. This independently retained metadata is preferably of such detail and specificity as may be necessary to independently verify or certify certain characteristics or aspects of a client information file, such as for example, the date and time the client information was uploaded to the repository system, the date, time, and details of whatever changes, if any, were made to a given file, and when or to whom the information was transmitted or sent.

The independent repository preferably retains control, preferably exclusive control over the metadata files. The client may request to examine some or all of such a metadata file or have access to examine some or all of it made available to certain other parties. Preferably, the metadata file cannot be altered by the client or any other party, and preferably once created, past entries are not, and cannot be modified by the repository (or the client). It is further preferred that the client be provided a mechanism to arrange limited access to client files by any other party of the client's choosing. Access may be limited to some or all of client's files stored on the repository system. Such limited access may include, for example, the ability to observe or download some or all client information during a predetermined time period but preferably not to edit or otherwise alter any such client information. Alternatively, such limited access may include, for example, the ability to add to the client information or to electronically sign a document belonging to the client or to fill out an electronic form. Some or all client information may also be sent by the repository to a person or entity designated by the client by using other mechanisms, such as for example, the US postal service. Preferably, any individual or entity may become a client of the repository by entering into a mutually acceptable agreement with the repository operator.

It is preferred that the repository system be physically located at a remote location distinct from locations controlled by client. However, a repository system may be located at a client site so long as it can be ensured that the client cannot manipulate or tamper with the metadata, cannot alter files associated with metadata files without such changes being reflected in the metadata, or otherwise meaningfully interfere with the operation of the repository system. While the description and claims may use the terms repository, operator, and client, it should be recognized that other terms such as, for example, party, first party, second party, third party and other party may also be used, and that a party, individual or entity described as a first party in one embodiment may be identified as the second party or by use of a different term identifier in a different embodiment, such that the terms repository, operator, client, party, first party, second party, third party, other party and similar terms should not be limiting in nature and should be given their broadest reasonable interpretation. For example, the term the client in the claims may be referred to as the first party, second party, the third party or the other party.

Client files may be stored on the repository system in their entirety as unitary files or as segmented files. Alternatively a client may elect to store only a segment of a file on the repository system with the balance of the file being stored elsewhere. Files may be split or segmented in such a manner as to create sub-files where access to a single sub-file may result in access to only some of the information in the original file. Alternatively, files may be segmented in such a manner such that sub-files cannot be interpreted individually and are meaningless by themselves. As a result, no information may be accessed unless all the sub-files or at least some of the sub-files are reconstituted into a unitary file. For an added layer of security, some or all client files, whether whole files or sub-files, may also be encrypted by client or by the repository.

The client and the repository operator in one option may have bifurcated control, but each may have certain rights and obligations. On one hand, the client may control the type or amount of information that is submitted to or collected by the repository for storage and preferably determines how long such information is to be stored. In order to remain a client, a person or other entity, may also have the obligation of abiding by certain rules set out by agreement or laws such as the timely payment of fees and avoiding the storage of unlawful information. The client may view the information submitted by or collected for client by logging onto the repository system and, for example, preferably submit required identifying information and a password. The client may also give access to individual files or groups of files, belonging to client, to others by, for example, generating appropriate user or login IDs and passwords for each such person or entity. It is preferred that once a non-client user logs on to the repository system, the user is asked, and more preferably required, to select a new password that is different than the client-assigned password.

If desired, a client may permit witnesses to view client files and make notes or add comments such as, for example, stating that they have examined and understood the content of a particular file at a particular time and date. Such notes or comments may be retained in various locations such as in the metadata file associated with a client file, in a separate file or within the client file itself. The client may also require or cause that some or all of the client information being stored at the repository be sent to another party designated by the client. This information may be sent electronically, by mail, or other means such as, for example, a package delivery or courier service.

Furthermore, it is preferred that the identities of those logging on to the repository be verified at least initially and at random times subsequently to ascertain that the person logging on is indeed the person to whom the logon id and password are assigned. To increase security, the repository may, for example, obtain identifying information about the computer being used to gain access to client files, such as ip address or other computer identifying information or equipment fingerprint, or require parallel telephone, email or biometric confirmation of a person's logon ID. For example, a person attempting to log on to the repository system, whether a client or someone authorized by a client may be instructed to call a telephone number. The caller's voice may then be analyzed and compared to voice records previously stored in order to confirm a person's identity. U.S. Pat. No. 5,365,574, which is incorporated herein by reference in its entirety, discusses a telephone voice recognition system.

The repository operator may be obligated by agreement to store the client's data and any associated metadata securely and to certify certain aspects of the client information to other parties when called upon by the client. The repository may also retain or be asked by client to retain earlier versions of modified files that are edited by the client or others authorized by client. For example, repository operator may be asked by the client to certify the date and time when the information was submitted by the client, when and by whom the information was accessed or modified, and the time, extent and details of any modification of the data. Any changes may be tracked, for example, by generating new versions at regular intervals or whenever changes are made by the client or other authorized users. Differences between versions of a file may be determined by using comparison programs, such as, for example, the compare tool available in Microsoft Word for comparing documents. Alternatively, all changes may be tracked and a record of the changes may be retained in the metadata. The client or client authorized users may log on and make the changes to client files on the repository system using appropriate repository provided application programs, such as, for example, a word processor or graphics program, or may make the changes on another system and upload new versions to the repository system for storage. The client may also specify special instructions which dictate the release or publication of specific documents under certain circumstances. For example, when a client passes away, the latest copy of their will may be released to specified individuals or entities upon receipt of a valid death certificate by the repository. Alternatively, client may select user or logon IDs and passwords that become active at certain times, as of a certain date, or when certain events occur. For example, a client may require that a particular set of passwords and IDs becomes active when documentation is provided to the repository that a child has graduated from college or has bought a house, or when the client has passed away.

The client may also use a repository to store certain electronic forms such as, for example, employment related Internal Revenue Service forms I9 and W4 that need to be filled out by new employees. Employees may then log on with the proper logon information and passwords that are preferably authenticated, provided to them by client, and fill out the forms. Once the forms are filled out, the client may be notified. Some or all employee data may be retained at the repository without being downloaded to the client system.

A client, such as a hospital, may store patient information, such as health and financial data, on the repository system. Doctors and other hospital personnel may then log on, with the proper IDs and passwords, and make modifications, make diagnoses, and prescribe medication. Patients, pharmacists, insurance company personnel and others may log on, with proper id and password information, and view and download certain information as permitted according to specified limitations associated with their logon ID and password. Preferably, a client such as a hospital will establish a separate file for each patient. For added security, patient information may be stripped of name and other identification information such as social security number.

Clients, such as, for example, employers and hospitals, may download some or all the information when and if necessary and as permitted by client specified parameters. Clients consequently need to store only a limited amount of such information on their own systems. Any changes to the files of such clients may be tracked, as any other client file on the repository system, and delineated in a metadata file.

The client may determine, for example, in which format client files are stored or be able to select from a menu of choices. The client may also determine when and if certain versions are deleted. The client may also elect to encrypt his or her files before they are stored at the repository so that the information cannot be viewed by anyone other than the client or those who are authorized by the client and given the necessary decryption key or keys.

The client is assigned or given the access and opportunity necessary to choose a unique logon ID and password that can be used to log on and upload files for storage on the repository system and to access such client files already stored on the system. The client may also request, for example, that the repository system require an authorized user to accept certain conditions, such as, for example, the terms of a nondisclosure agreement prior to gaining access to client's information. The date and time of the acceptance of such information may also be added to the metadata.

The client may create a logon ID and passwords for others that would enable such individuals to access some or all of the client files. The client may limit the access by others, for example, to only read or download files but not permit them to edit or delete the files. Alternatively, the client may permit access to certain parties where they may edit or alter a client file, but where change tracking cannot be turned off. The access by a client or by others may require fingerprint or other biometric scans or authentication of identifying information about a computer or other electronic equipment used to log on to the system. Biometric scanners may be installed at the physical repository location for use by clients or users, at satellite locations under at least partial control of the repository personnel or at other sites preferred by the client. Clients and client authorized users may be required to create unique IDs and passwords from locations that are managed or at least partially controlled by the repository or as directed by repository personnel who may be present at a user location. For example, the client may be asked to go to a site such as, for example, a UPS store where an employee or contractor of the repository checks identity documents such as a driver's license or passport before permitting the system to generate a user ID and password for the client or for individuals the client wishes to have authorized access.

Once a client is assigned such a verified user ID and password, they may be used to communicate with the repository over a network. The repository may also certify the particular logon or user ID and passwords of such clients for use on other networks or systems. For example, the repository may certify the logon IDs and passwords of a client for the purpose of accessing the computer system for a third party, such as, for example, a bank or online vendor. The repository may require subsequent or periodic supplemental authentication of logon IDs and passwords.

Metadata generated by the repository system may include data such as ip address and certain other unique or near unique identifying information, such as, for example, the fingerprint of computers used to log on to the repository system to access the client's stored data.

Metadata may also track changes in various file specific information, such as checksum or file size of client files. The client may be allowed to view some or all of the metadata and to allow others to view such information as well. However, the client is preferably precluded from erasing, editing or otherwise manipulating at least certain information or fields in the metadata. It is preferred that metadata be stored in a separate file that is appended to or stored in the same folder as an associated client file. The metadata may also be incorporated into the client file preferably so long as the client is restricted from modifying at least certain of the metadata information.

It is another object of this invention to provide a limited access, network accessible, electronic data storage facility or repository wherein the repository system is used to independently obtain and store copies of electronic data exchanged over a network, including, for example, emails, documents and text messages with or without attachments, among two or more parties, upon the request of at least one of the parties. Also collected is certain information or metadata about such electronic information exchanges. This independently retained information or metadata is of such detail and specificity that it may be used to independently verify or certify certain characteristics or aspects of the transferred electronic information. For example, a repository system may be authorized by a client to obtain and retain copies of all or certain emails, including attachments, exchanged between client and one or more other entities as well the names of all the recipients of the emails and attachments to such emails. Metadata collected may include, for example, the time and date of each such transmission and each response.

In an embodiment according to the invention, an online repository is used to store copies of, for example, emails, text messages and other electronic documents exchanged over a network between a client and one or more other entities. For example, a client, negotiating the purchase of an asset with another party may use the repository as a pass through facility to keep track of his or her outgoing and/or incoming communications with one or more parties. The client may direct copies of some or all outgoing emails to, and some or all incoming emails from, such a party to the repository for storage. Alternatively, the client may allow a variety of outgoing and/or incoming electronic communications to be delivered by the repository and request the repository to filter out certain communications, for example, those from and/or to a particular email address. The repository may be asked by the client to retain copies of all communications received from or on behalf of the client or certain selected communications. This would serve as electronic certified mail but be superior to sending such messages by certified or registered mail. In the case of certified mail, for example, the postal service could certify that a package was sent and where it was sent and received. In this embodiment, the repository would in addition be able to certify what was sent. The repository may collect and retain such information as necessary to certify certain aspects of the communications, such as for example, when one or more emails were sent, the email address of each sender, the email address of all recipients, the files attached to each email and any responses. The client may send copies of emails to the repository by using certain fields of an email interface, such as the cc or bcc fields or other custom fields, and requesting incoming mail to be forwarded to repository automatically, for example, by the email service provider. Alternatively, the repository may be authorized to collect such information from, for example, the client's outgoing and incoming mail servers. Such information may be collected and stored with or without the knowledge of one or more of the parties with whom the client is communicating.

It is yet another object of this invention to establish one or more ingoing and/or outgoing proxies at the repository for the purposes of electronic communication with third parties. Proxies may be used to send and receive communications on behalf of the client. Each such proxy may be configured so that client may send outgoing electronic messages, such as for example, emails or text messages, to the proxy. Such messages are preferably forwarded to addresses or telephone numbers specified by the client from the proxy at the repository. Electronic messages received by the proxy are, in turn, preferably forwarded to client at a predetermined address or telephone number. Copies of outgoing and incoming messages and attachments are preferably retained by the repository. A metadata file may be generated to track how and by whom this information was viewed and/or modified. Documents or information in messages transmitted electronically between the client and/or others, for example, in an email or text message may be transmitted by the repository using the client's proxy email address or using, for example, a repository email address and/or phone number.

It is still another object of this invention to provide a limited access, network accessible, electronic data storage facility or repository wherein information published on one or more websites on the internet may be independently monitored by the repository and recorded and time stamped for or at the behest of a client of the repository. Such data may be used to independently verify and certify, for example, when certain information first appeared on a particular website, when and how it was first altered or subsequently deleted. The repository may also be requested by the client to search, for example, a specified website or web page for particular information, such as, for example, a certain keyword, a person's name, the name of a product, or the photograph of a person or product. The client may instruct that such information be stored in a client file and, additionally or alternatively, may request notification by, for example, email or text message, when certain information is detected. One or more pages of the website may be monitored by, for example, accessing such pages at a frequency requested by client such as, for example, hourly, daily, weekly or at more or less frequent intervals. A record may be made of the entire page, for example, each time such a page is accessed. Alternatively, a record may be made of the entire page or website or portion thereof, only when a change or certain prescribed changes are detected. Certain changes, such as time and date information on the accessed page may be ignored. Alternatively, only the information added, deleted or altered may be noted and recorded in a client file by the repository. Preferably the date and time the information is obtained is also stored by the repository. Preferably the date and time the information is obtained is also stored by the repository.

It is yet another object of this invention to provide a limited access, network accessible, electronic data storage facility or repository wherein a client may request the repository system to conduct searches with certain specifications on networks, such as the internet, using search engines such as, for example, Google and to record the results. A metadata file may also be generated to track how, by whom, and for how long this information was subsequently viewed, downloaded, uploaded, copied and/or modified.

It is still a further object of this invention to provide a limited access, network accessible, electronic data storage facility or repository wherein the contributions of multiple individuals or organizations cooperating in the performance of a joint project or endeavor are collected, tracked and recorded so that the contribution of each and its timing can be verified and certified. This may entail uploading text, images, and screenshots of computers or certain files at regular, irregular or certain intervals for storage at the repository. In addition, the repository may be used to record voice, video, text and/or computer screen-shots during, for example, telephone conferences, video conferences, computer chats and/or text exchanges.

For example, the repository may be used to record a telephone conference, wherein information may be tagged and segregated by the incoming telephone number or by using voice recognition so that the contribution of each participant can be tagged and tracked in a metadata file. Speech recognition may be used to convert speech to text such that a transcript of a conference is produced and stored including the identification of speakers. Voice or face recognition or other biometric analysis technology may be used to identify persons speaking during a conference call. The identity of the speaker may be broadcast in real time to participants in a conference call between two or more individuals or be stored as part of the client file, so the identity of the speaker can be matched with the transcript of a conference call. For example, during the conference call the identity of the speaker, which may be identified by speech recognition or other methods, may be posted on a visual display, such as for example a computer monitor or screen, a smartphone or a screen of a VoIP phone system. The identity may be displayed as the name of the speaker and/or a picture of the speaker on the visual display. In one embodiment, the names and/or pictures of all the participants on the conference call can be displayed with the speaking participant being specifically identified by the system, preferably through a visual display means or method. The repository may also be used to record conversations and produce transcripts automatically through the use of voice and speech recognition in other settings such as courtrooms or meetings. This can be done live or from a recording. Under certain circumstances, it may be preferred to convert speech to text without recording the voices of one or more participants in a conference. It may be preferred that the conference calling center be located in the facilities of the repository. U.S. Pat. Nos. 6,661,779 and 7,317,791, both of which are incorporated herein by reference in their entirety, describe the use of telephone conferencing systems.

It is yet a further object of this invention to provide a limited access, network accessible, electronic data storage facility wherein, upon a client's request, certain or all copies of client documents, stored at such an independent repository, may be printed and shipped to one or more entities or persons. A certificate verifying, for example, when the information being sent was delivered to the repository and when, by whom and how said information was changed may be included. Documents or the certificate may be marked with verifiable watermarks or other unique and secure markings or serial numbers that identify such documents or certificates as having been generated by the repository system. Information may also be added to the electronically stored metadata associated with such client electronic documents specifying when and to whom the hard copies of documents were sent and where and by whom they were received.

It is yet a further object of this invention to improve the security of electronically stored client information by splitting critical files into two or more sub-files that may be stored in separate locations. One or more of these sub-files may be stored on an independent, limited access, electronic data storage facility or repository. For example, forms such as employment forms and loan applications may be configured so that information contained in certain fields is kept separately from the remainder of the data. The sensitive information may be stored locally or remotely on an independent computer system. Access to the sensitive information may require passwords and be limited, such as, by limiting the number of sensitive sub-files that may be accessed by a single person or by anyone over a certain time period such as, for example, an hour, a day or a week.

By strategically selecting how the file is split into sub-files, the processing of files may proceed unhampered. Institutions such as, for example, banks, federal, state and local governments and schools and various employers, frequently require extensive amounts of information that are necessarily stored on network accessible computers. For example, banks will frequently request that tax returns be submitted as a part of a loan application. Tax returns may contain extensive sensitive information, such as, for example, names and social security numbers of applicants and various family members including minors, home addresses as well as bank account information. However, such sensitive information is not necessarily required in each step of the evaluation process nor is it necessary on a continual or regular basis. It is an object of this invention to store the sensitive information separately in one or more sub-files which may be stored in one or more physical locations. The system may fuse or aggregate only such information as is necessary for any given task or stage in the process, for example, the verification of employment. It may do so only when proper passwords or other identifying information are supplied and/or authenticated by the individual wishing to gain access. But verification of employment may not require all sensitive information that is available to the system, such as bank account information. It is, therefore, preferred that the system fuse only such information as is necessary and allowable under the access level, a given task or permitted for a given user. The fused information may be retained or displayed for the user only to the extent and for the time period necessary.

Distributed file storage may be configured in a manner that permits certain sub-files to be used without accessing the remaining sub-files. For example, a retail store may keep the first initial, last name, and credit card numbers of customers in one sub-file but the address, phone number and other identifying information in a second sub-file that is stored in a different location locally or remotely. Certain sub-files may be stored at a remote location such as an independent, limited access repository.

For added security, certain information in certain sub-files may be dummy or false information. If the security of the storage system of one group of sub-files is compromised, the entity gaining illicit access to the sub-file may not know which data is legitimate data and which is dummy data. If an attempt is made to use such dummy data, such an attempt may be used as an indicator that there has been a breach of security.

Alternatively, the sub-files may be split into associated sub-files in such a manner so that only certain bits of information from each byte or certain bytes of the file are stored in a sub-file. As a result, no sub-file is intelligible without one or more of the other associated sub-files. In this way no sub-files can be interpreted without access to some or all of the other associated sub-files.

In order to minimize the amount of damage that may result from illicit access, users requesting access to sub-files may be limited to a maximum number of sub-files in a given time period, such as, for example, in a given hour or day. The system may also request additional passwords, such as from a supervisor, to allow certain or additional sub-files to be accessed.

In one embodiment a method for storing information on a network accessible data repository system is disclosed comprising the sequential, non-sequential and/or optional steps of a repository, for example, providing a microprocessor based or computer based system having an information storage database having file storage; providing limited access to said system to an independent first party also referred to herein as the client; storing information in at least one file on the system; providing access to the first party files to the first party; creating at least one metadata file on the system that comprises a historical record of the information stored in the at least one file; and providing access to a second party different than the first party to at least some of the information in said metadata file as directed and limited by the first party. The historical record may comprise at least one of the group consisting of when and by whom at least some information in the first party file was uploaded, downloaded, copied, viewed and modified.

In a further embodiment the method may further comprise allowing the second party access to at least some of the information in the at least one first party file as directed and limited by the first party. In some embodiments at least a portion of the information stored in the at least one file on the system may be uploaded using the internet. In another embodiment, at least a portion of the information stored in the at least one file on the system is obtained by the operator of the repository from various websites on the internet as directed by the first party. The method may further comprise providing a certificate identifying the date when information on the system existed, was uploaded, downloaded, copied, viewed or modified.

In a further embodiment a method for tracking information available on the internet is disclosed comprising the sequential, non-sequential and/or optional steps of receiving a request from an independent party to copy and store at least a portion of the content of at least one page from at least one specific website; accessing the at least one specific website; copying and storing at least a portion of the content of the at least one page of the at least one specific website; and making the content available for viewing, copying or distributing. In one embodiment of this aspect of the invention, the accessing, recording and storing of said content is repeated at a frequency requested by the independent party. In another embodiment of this aspect of the invention, accessing the content of said at least one page of said website at a requested timing frequency, and recording and storing the content occurs only when the content has changed. This embodiment may further comprise the step of making the content available to others as specified by the independent party.

In yet a further embodiment a method for facilitating a network accessible conference is disclosed comprising the sequential, non-sequential and/or optional steps of establishing a communication link among three or more participants in a conference communication; using voice recognition to identify the participant speaking in real time; and transmitting the identity of the speaker to at least one of said participants. The embodiment of this method may further comprise the step of using speech recognition to convert speech to text, and/or the step of storing the text in a client file on a network accessible data repository system that is independent of the conference participants. In one embodiment of this method, transmitting the identity of the speaker to at least one of said participants may include providing at least one of the speaker's name and picture onto a visual display. The embodiment may further include at least two of the participants using the same speaker phone to participate in the conference.

Various features of the invention described herein may be used singularly or in combination with other features including features not described herein. The objectives indicated are not intended to be exhaustive.

### BRIEF DESCRIPTION OF THE DRAWINGS

The foregoing summary, including the above and other features and advantages of the repository, verification and certification system and method, as well as a brief description of the preferred embodiments of the inventions will be better understood when read in conjunction with the appended drawings. For the purpose of illustrating the preferred embodiments of the present inventions, and to explain their operation, drawings of preferred embodiments and schematic illustrations are shown. It should be understood, however, that the invention(s) are not limited to the precise arrangements, variants, structures, features, embodiments, aspects, methods, advantages, improvements and instrumentalities shown, and the arrangements, variants, structures, features, embodiments, aspects, methods, advantages, improvements and instrumentalities shown and/or described may be used singularly in the system or method or may be used in combination with other arrangements, variants, structures, features, embodiments, aspects, methods and instrumentalities. In the drawings:

FIG. 1 shows a schematic of a network where personal computers are used to communicate over the internet with a repository embodiment configured according to an aspect of the invention.

FIG. 2 shows a schematic of another aspect or variant of the embodiment in FIG. 1.

FIG. 3 shows an exemplary flowchart for submitting files for storage in a repository.

FIG. 4 shows an exemplary client sign up sheet.

FIG. 5 shows an exemplary metadata file generated by the repository system.

FIG. 6 shows an exemplary file structure for storing client files.

FIG. 7 shows a schematic of an aspect of a further embodiment according to the invention.

FIG. 8 shows a schematic of an aspect of another embodiment of the invention.

FIG. 9 shows a schematic of an aspect of yet another embodiment of the invention.

FIG. 10 shows an exemplary information submission sheet with fields that are stored separately in electronic form.

FIG. 11 shows a schematic of an aspect of yet a further embodiment of the invention.

FIG. 12 shows a schematic of another aspect of the invention in FIG. 11.

FIG. 13 shows a schematic of an aspect of still another embodiment of the invention which incorporates a conference calling center.

### DETAILED DESCRIPTION OF INVENTION

Certain exemplary embodiments will now be described to provide an overall understanding of the principles of the structure, function, manufacture and use of the system and methods disclosed herein for depositing, storing, verifying and verifying information, including electronic data. One or more examples of these embodiments are illustrated in the accompanying drawings and described herein. Those of ordinary skill in the art will understand that the systems, methods and examples described herein and illustrated in the accompanying drawings are non-limiting exemplary embodiments and that the scope of the present invention is defined solely by the claims. The features illustrated or described in connection with one exemplary embodiment may be combined with features of other embodiments and that the features may be used individually, singularly and/or in various combinations. Such modifications are intended to be included within the scope of the present invention.

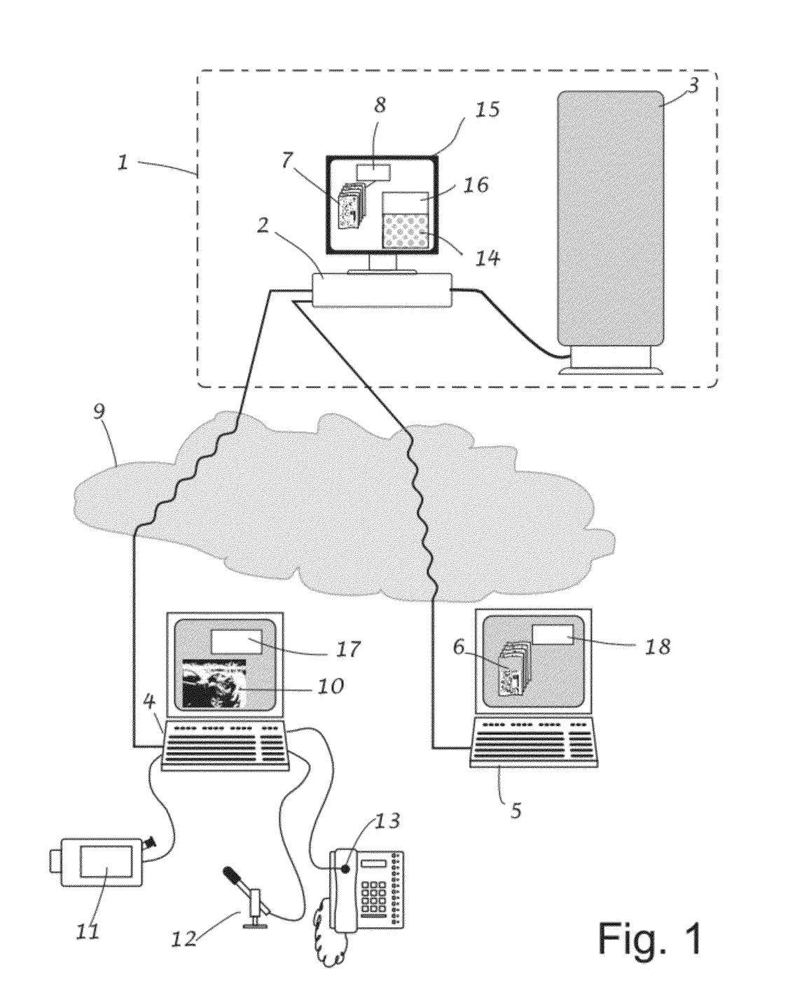

FIG. 1 illustrates an aspect of a repository system and method configured according to an embodiment of the invention. The repository system 1 comprises a server 2 and storage device 3. Storage device 3 may comprise, for example, one or more disk drives, flash drives or tape drives. Files from one or more clients may be uploaded to server 2 and stored in the storage device 3. Client computer 4 and client computer 5 communicate with repository server 2 over a network 9 such as, for example, the internet. A client document comprising video, pictures or images on client computer 4 is represented in FIG. 1 by image 10. The video or images in such a document may be, for example, captured by using camera 11, that may be connected to computer 4, scanned using a digital scanner (not shown), downloaded to computer 4 over a network, or created by using various graphics programs such as PhotoShop or Core1 DRAW. Client documents may also comprise acoustic recordings captured using, for example, microphone 12 or telephone sensor 13. Any of these documents may be manipulated on client computer 4 and then uploaded to the repository server 2. The repository system 1 may comprise one or more servers or computers. It is preferred that repository system 1 be located at a remote physical location distinct from the client. However, the client system(s) and the repository system may be co-located at the same physical location preferably so long as the client cannot manipulate or tamper with client files on the repository system in a manner that cannot be tracked and recorded by the repository, for example, in a metadata file.

Client files may be encrypted or split into sub-files so that the operator of system 1 cannot effectively access, view or manipulate their contents. For example, the system may only be able to display the client document as icon 14 on a system monitor 15. Nevertheless, when the document 10 is uploaded to server 2 as an encrypted document or a sub-file represented by icon 14, it is tagged with metadata file 16 which is accessible to the operator of the system 1. After uploading the file, the client or those authorized by the client may modify or edit the client document. The client may establish document access rules that determine how and by whom the client document may be edited or accessed. For example, the client may determine that certain users may view and edit documents without saving earlier versions while other users must retain all versions. Client may also request to be notified whenever any changes are made to client's files, what those changes are and by whom they were made.

In FIG. 1, client computer 5, which may belong to a different client or entity, may be used to transfer document 6 to the server shown as unencrypted file 7 on monitor 15 of the system 1. The system again generates and associates or appends a metadata file 8 to document 7. Preferably at least some of the information in metadata files 8 and 16 may be observed by clients or downloaded as files 17 and 18. Items 6, 7, 8, 10, 14, 16, 17, and 18 in FIG. 1 represent various files that are stored by computers 2, 4 or 5.

Various types of documents that may be stored on a repository system include, for example, correspondence, pictures, video and audio recordings, computer algorithms, computer programs, musical scores, song lyrics and writings. File 16 and document 14 may be stored on memory device 3 as associated or appended files so that the system can readily determine that file 16 is the metadata for document 14. A client may log on to the system to, for example, access file 7 and download it to client computer 5 or to manipulate the file on server 2. The system 1 will preferably track all such activity or changes to file 7 on server 2 and record such changes in activity in metadata file 8. For example, if client modifies file 7, the system will update file 8 to reflect the changes that were made and the time and date when the file was saved after the modifications. Alternatively, if it is difficult or cumbersome, it may be preferred that changes be tracked by retaining earlier versions of the files. Also, if a client downloads the file and makes changes and uploads it again, the system may treat the file as a new file or a new version of the old file based on the client's preference. If desired, clients and users may use other devices such as, for example, smartphones, tablets and other microprocessor based appliances, instead of “computers” to communicate, download and upload files and otherwise interact with the repository.

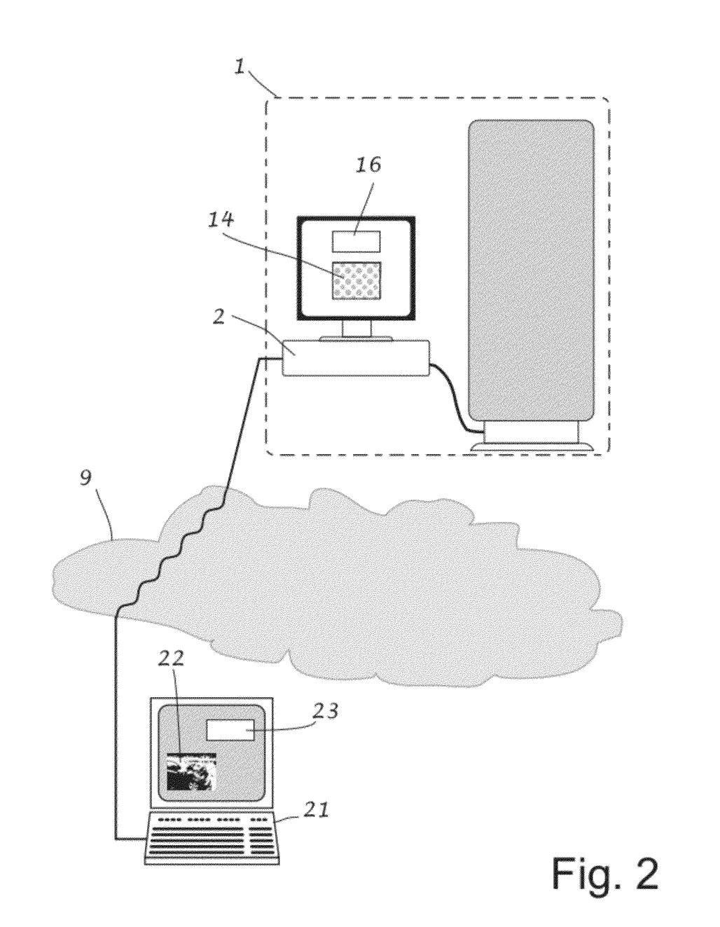

FIG. 2 shows another aspect of the embodiment in FIG. 1 comprising repository system 1. An entity authorized by the client owner of the file represented by icon 14 in FIG. 1, using computer 21 and network 9 may log on to repository server 2. Using required user identification password and an encryption key supplied by owner of the file, such a user may manipulate the client's files if within limits authorized by the client. Such authorized entity may gain access to client file indicated by icon 14 and, for example, download and decrypt copy of client file as file 22. The system may also supply a certificate file 23, as authorized by the client, verifying certain facts about client file represented by icon 14.

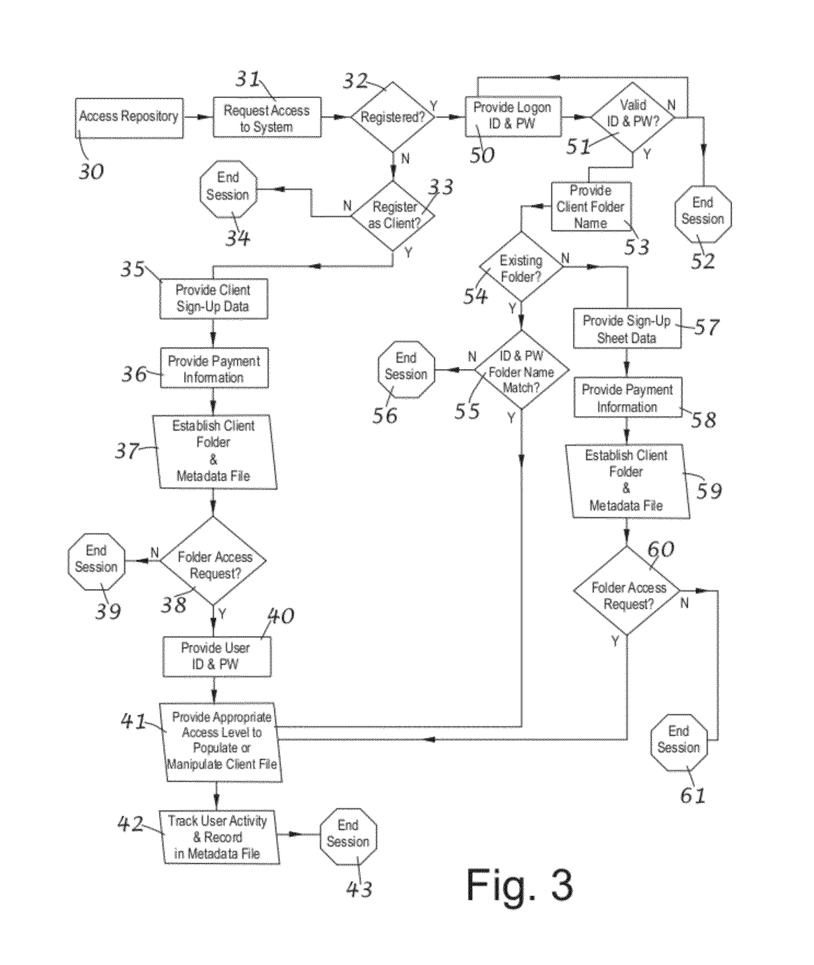

FIG. 3 is an exemplary summary flowchart illustrating how a client folder may be established, populated or modified. A prospective client, a client or a non-client user may access a repository website using a network such as the internet. A prospective client may be an individual who wishes to establish one or more folders at the repository. The client is responsible for providing required information such as, for example, the client's name, address and contact information and paying for the service. A client may establish logon IDs and passwords to be used by one or more users to access one or more of the client's folders.

The client may also supply information about all of the users who are to be permitted access to the contents of a client's folder. Included in the information provided by client for each user may be a user ID and password as well as the type or level of access each user is permitted to have to a client's folder.

FIG. 3 shows Block 30 wherein an existing or new client or user accesses a repository website by using the internet. In Block 31, a request is made for use of the repository system. In decision Block 32, the repository system queries the person seeking to gain access to determine whether he or she is already registered. In decision Block 33, a person who is not already registered may choose to terminate session in Block 34 or elect to continue in order to register as a new client. In this embodiment, a person who is to gain access to a client file as a user must have already been registered by the client and assigned a password and logon ID.

In Block 35, the prospective client provides information requested by the repository including, for example, the name and address of the client, contact information, as well as logon IDs and passwords for the client's representatives as well as any other users to whom the client wishes to grant access to client's folder(s). In Block 36, the prospective client provides information necessary for payment for services. Once all necessary information is collected, Block 37 illustrates that the system establishes one or more client folders that can be used to store client information and associated metadata files that are used to store tracking information about the client folder or file.

In Block 38, the system determines whether the new client wishes to access a newly created client folder. The session may end in Block 39 or continue in Block 40 where a logon ID and password are requested. In Block 41, the system permits the appropriate level of access to the appropriate client folder. Block 42 illustrates that the system tracks changes to client information stored in the client folder until session is ended as indicated in Block 43. A record of such changes is kept in the metadata file which is associated with or appended to the client file, included in the client folder or otherwise associated with it. The client related information stored in a client folder preferably comprises a single client file and its associated metadata file.

If in Block 32 it is determined that the requester is an existing user or client, the system requests a logon ID and password in Block 50. In decision Block 51, logon ID and password are checked. If the logon ID and password are not valid, the requester may be given one or more opportunities to provide the correct requested information or the session may be terminated in Block 52. In Block 53, the non-client User or Client, whose logon ID and password have been checked in Block 51 and found to be valid, is asked for the Client Folder Name to be accessed. If in Block 54, it is determined that the name provided is for an existing folder, and in Block 55 that the logon ID and password are valid for access to the particular folder identified, the client or user is given access to the client data in the folder, commensurate with parameters established by the client and the repository operator. If it is determined that the logon ID and password are not valid for the particular client folder, the session may be terminated in Block 56.

If in Block 54 it is determined the file name provided in Block 53 is not an existing file, an existing client may be allowed to establish a new client folder with the particular name. In Block 57, the system requests that a new sign-up data sheet be provided for the new client folder. In Block 58, the client supplies requested payment information. In Block 59, the repository system creates a new client folder for the client that can be used by the client to upload and store the client's information. The system may assign the client folder name provided in Block 53 to the folder and simultaneously create an associated metadata file. In Block 60, it is determined if immediate access is being requested to the new Client Folder. If it is not, the session is terminated in Block 61. Alternatively, the system provides appropriate access to the Client Folder based on the parameters established in Block 57.

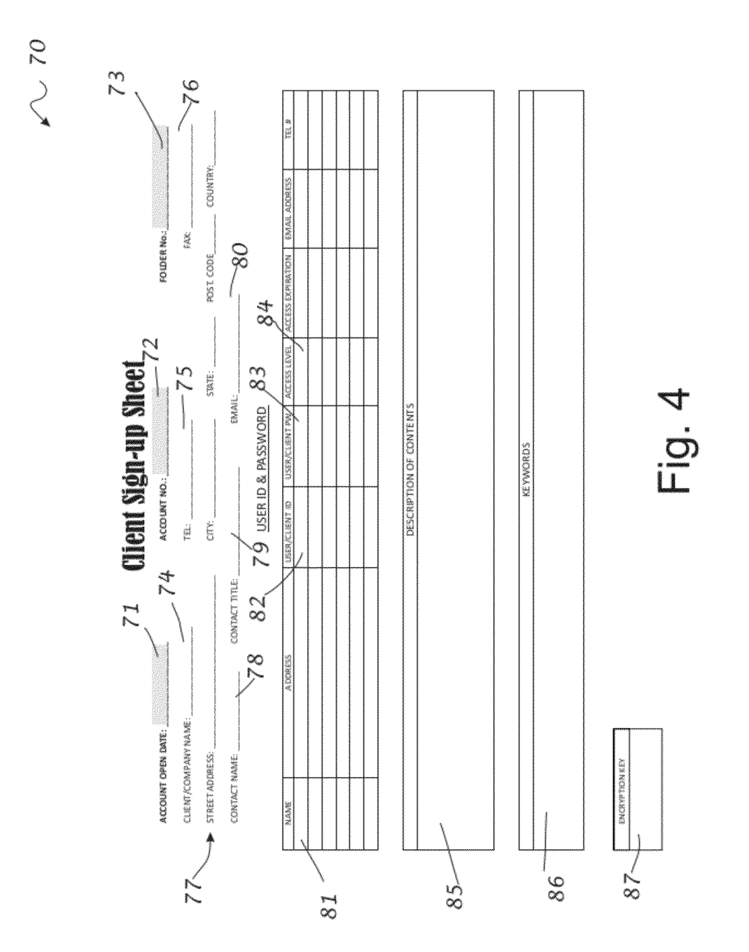

FIG. 4 shows an exemplary electronic Client Sign-Up Sheet 70 that may be used by a client to create a new client folder at a repository. Certain identifying information, such as Account Open Date 71, Account No. 72, and Folder No. 73, may be automatically provided by the repository system. Information such as Account Number is preferably unique. The client may provide information, such as Client name 74, Telephone Number 75, Facsimile Number 76, Address 77, Contact Name 78, Contact Title 79 and Email Address 80. The client may also specify one or more User Names 81, User IDs 82 and Passwords 83 and other identifying information for users that client wishes to grant access to a particular folder. The client may further specify different Access Levels 84 and Access Expiration dates for each particular person or entity. It is preferred that such information be provided electronically by a client although other means such as the mailing of a filled in Sign-Up sheet may be utilized. Description of the Contents 85 of the folder and descriptive Keywords 86 may also be provided so that a search utility may be used to locate particular folders and files without accessing the actual content of the files. Client may also provide an encryption key 87, although a client may elect to withhold such information.

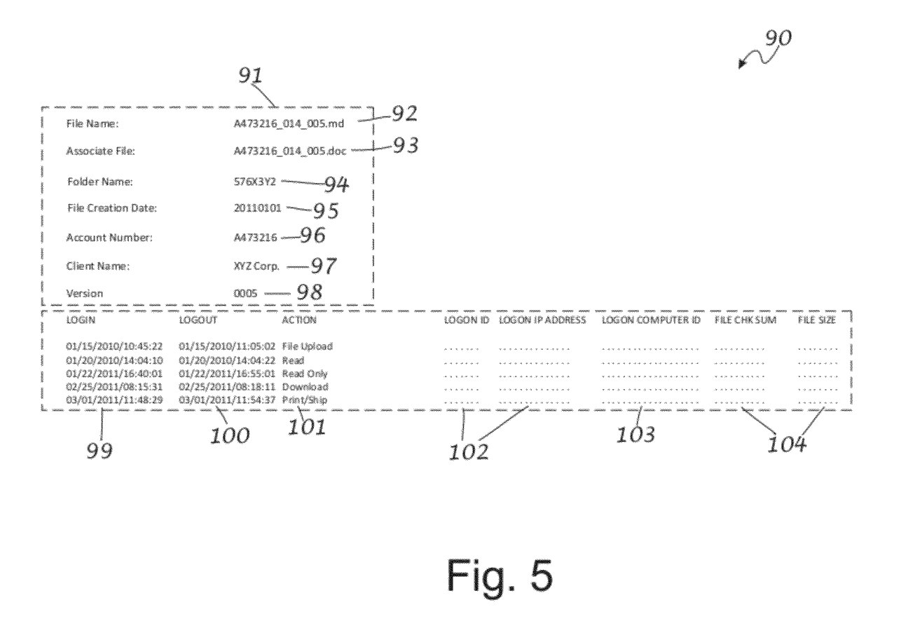

FIG. 5 shows an exemplary metadata file, such as file 8 and file 16 in FIG. 1 which may be generated by system 1 and appended to or associated with unencrypted file 7 and encrypted file 14 respectively. Such a metadata file 90 may include a header 91 which may comprise the metadata file name 92, the name of the client file with which the metadata is associated 93, name of client folder 94, date the file was created/uploaded 95, account number 96, the name of the client 97, and the version or generation of the client file 98. A metadata file header may be generated automatically by the system incorporating information provided by the client. The metadata file also comprises tracking information such as when a user viewing or manipulating the associated file has logged on 99 and off 100, the actions taken 101, various user specific data 102, data specific to user's computer 103, and file specific data 104. File specific information may comprise information at the time of login as well as at the time of logout. The client may be able to observe some or all of the information in file 90, and may allow others to view it as well. When requested by the client, system 1, will provide such certification as is requested by the client to any other party based at least partially on data in file 90. For example, the system, by referring to fields 99, 100, and 101, may provide certification to a third party that, for example the contents of the encrypted file represented by icon 14 in FIG. 1, have remained unaltered since Jan. 15, 2010 at 11:05:02 and were last accessed on Mar. 1, 2011 at 11:54:37.

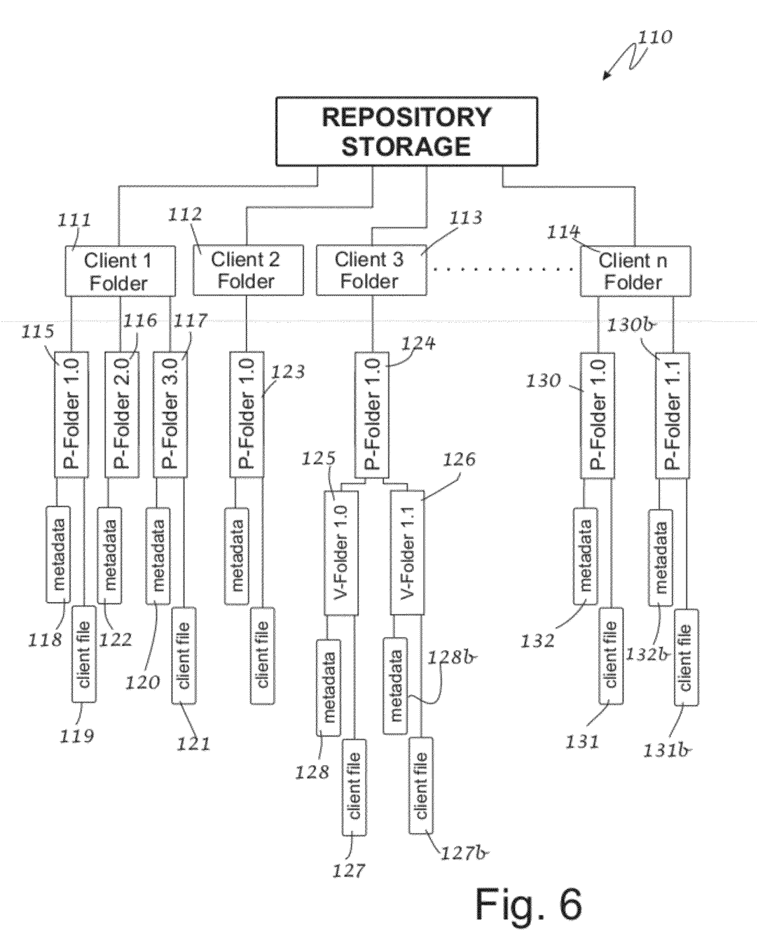

FIG. 6 illustrates an exemplary file structure 110 for storing client folders according to an aspect of an embodiment of the invention. A master client folder, such as folders 111, 112, 113, or 114 is established as requested by the client in a repository storage device. One or more individually designated project subfolders may be established for the client files. For example, the client folder 111 has three project folders, 115, 116, and 117. Each project folder 115 and 117 has client files 119 and 121 respectively. Metadata files 118 and 120 are associated with files 119 and 121 respectively and are preferably stored as distinct files in project folders 115 and 117. Project file 116 has been established by Client 1, but does not yet contain a client file. Metadata file 122 may contain, for example, folder creation data. Client 2 has established folder 112 with only a single project folder 123. Under certain circumstances, it may be preferable to track changes to client files by creating a new version each time a file is modified. For example, project folder 124 under client folder 113 contains two version folders 125 and 126. Folder 125 contains client file 127 and associated metadata file 128. When file 127 is altered, either on the repository system or modified and uploaded, the system may create a new version folder 126 that contains updated file 127b and updated metadata file 128b. Client folder 114 is shown with project folder 130, client file 131 and metadata file 132. Client may choose to duplicate folder 130 as 130b containing client file 131b which may initially be identical to file 131. Metadata file 132b, which may be automatically created by the system, may also start out largely identical to file 132, but may have an indication that it was initiated as a duplicate of another client file. Creating duplicate project files may be desirable, for example, when a client wishes to pursue two different paths after a certain point has been reached in a project. Client information stored in, for example, folder 116 belonging to client 1 may contain a file uploaded by client 1, information collected by the repository system from one or more websites designated by client 1 or the transcript or audio recording of a conference call that client 1 participated in.

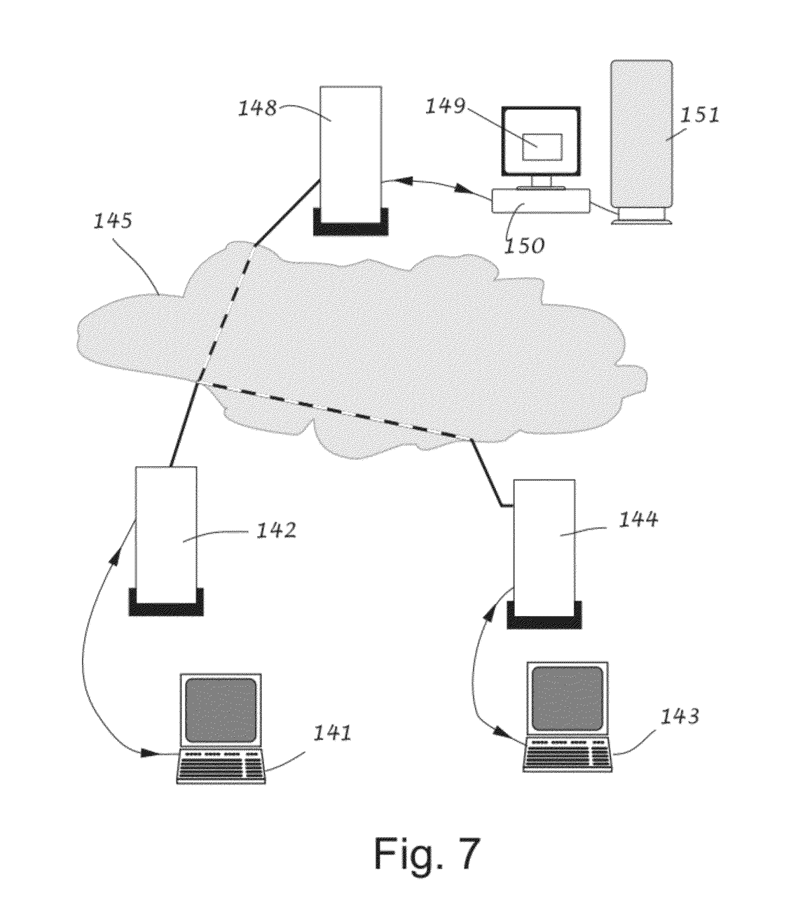

FIG. 7 shows an embodiment of the invention where client using computer 141, connected to mail server 142, is exchanging electronic messages with a third party using computer 143 via mail server 144 using the network 145. Mail server 142 mirrors both outgoing and incoming messages to mail server 148 of the repository system. The repository server 150 stores some or all communications between 141 and 143 in file 149 along with attachments and time and date of each message. The repository may then make available a document that certifies when messages were sent or received, to whom they were sent and the contents of such messages.

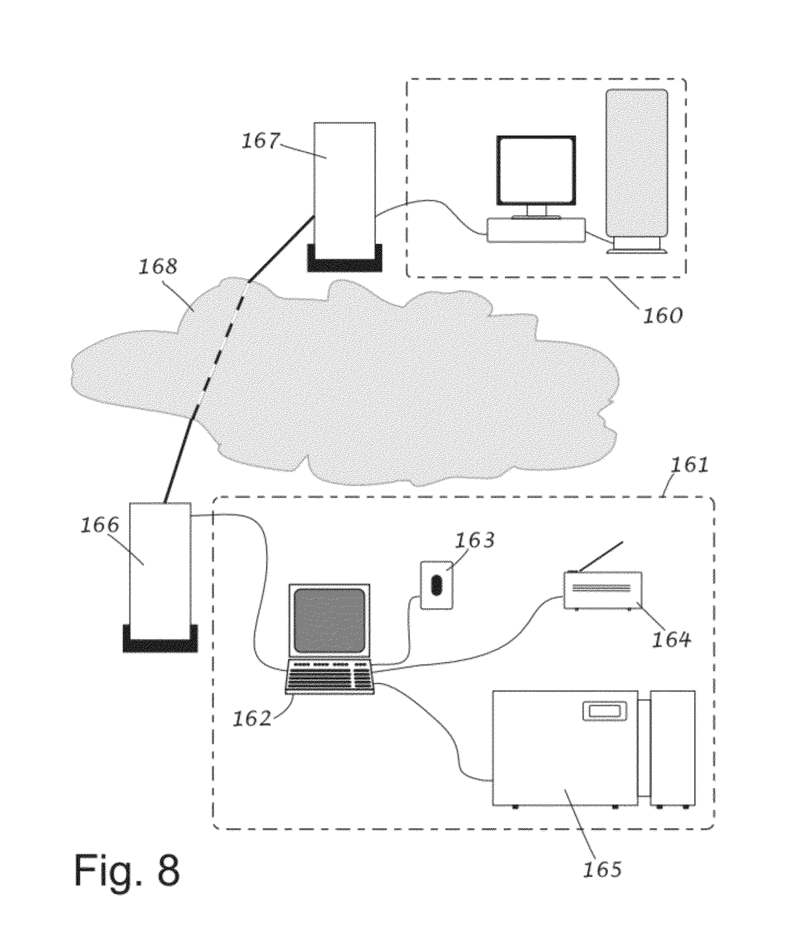

FIG. 8 illustrates an aspect of another embodiment according to the invention which comprises repository system 160 and satellite system 161. Satellite system 161 may comprise a computer system 162, fingerprint scanner 163, and document scanner 164 which may be utilized to generate verified logon ID and password for clients. Such verified logon ID and passwords may be generated after personal identification, such as, for example, a passport or driver's license, are checked by repository personnel or contractors. Satellite sites may also be used to print client files using printer 165 in order to ship to third parties, when requested by a client. It is preferred that the location of the satellite facility selected be as close to such third party as is available. The repository system 160 may communicate with satellite system 161 utilizing servers 166 and 167 and network 168.

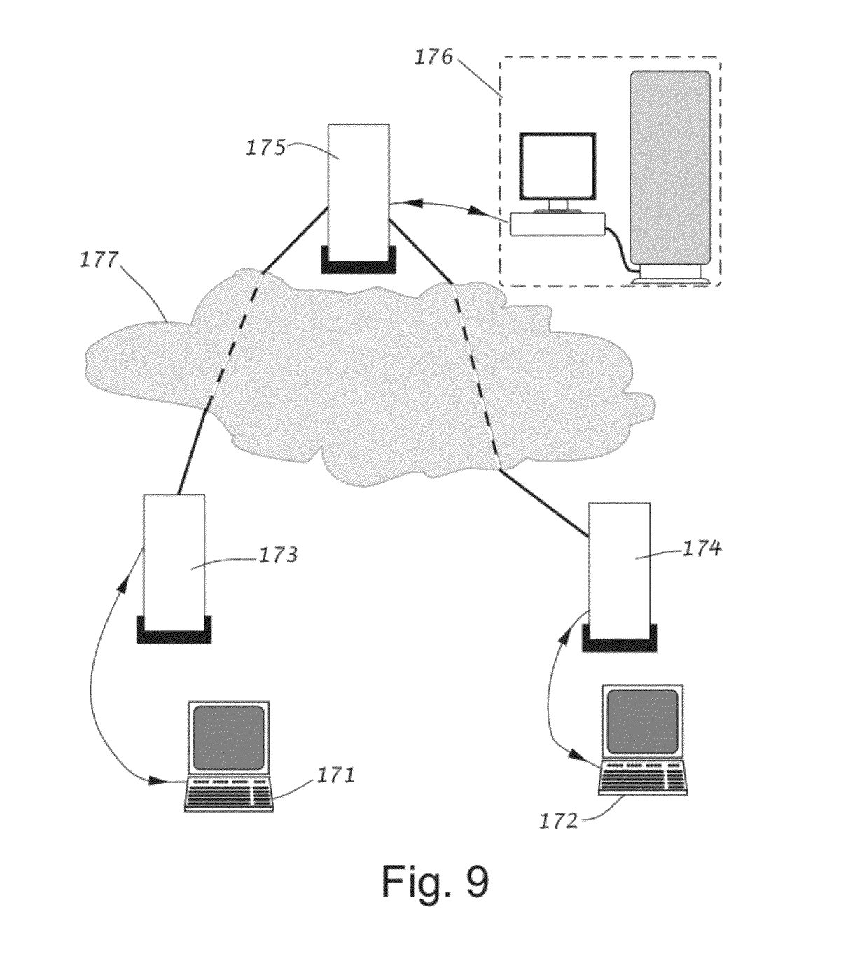

FIG. 9 shows an embodiment of the invention where two clients or users using computer 171 and 172 and servers 173 and 174 communicate with server 175 over a network 177. Each client or user supplies certain information that is consolidated and stored on repository system 176 in a file belonging to at least one client. The contribution of each client or user is tagged and recorded in one or more metadata files so that the content and time of each client or user contribution is stored at the repository. Two or more individuals may then cooperate in, for example, signing an agreement, or developing a concept, a design or the lyrics of a song in a manner where the actions or contributions of each are noted. Clients or users may cooperate in this manner regardless of where they are located physically with respect to each other or to the repository.

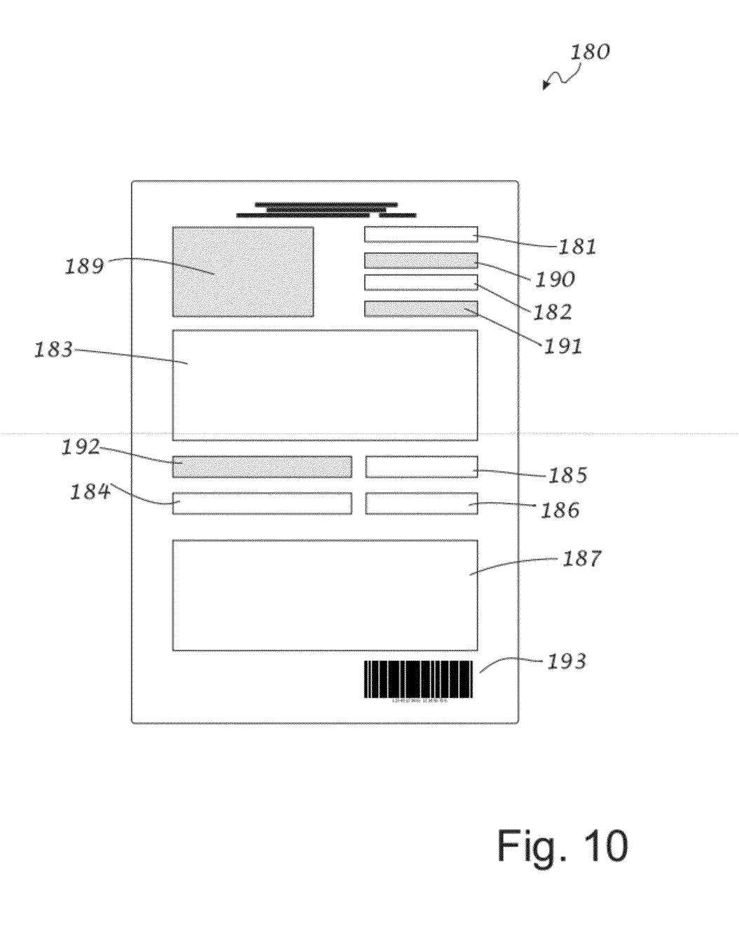

FIG. 10 shows another aspect of an embodiment of the invention which comprises a form 180 with multiple fields. The form may be a paper form or an electronic form. When the form is filled out and processed, the information in, for example, fields 181 to 187 (Group A) are stored electronically, and preferably separate from information in fields 189-192 (Group B) by the system processing the form. The information in Group B may, for example, be sensitive and may be stored at a repository. It may be encrypted and/or additionally protected by passwords. The information in Group A may be stored locally on a client system.

The form may include form identification data such as, for example, a barcode serial number 193 if the form is a paper form or an electronic serial number in the case of an electronic form. The system may correlate data in Group A and Group B for each file so that it can be reconstructed by the system by using the file serial number when the proper password is provided by a user. Multitiered passwords may be used such that the system reconstructs the file to various degrees based on the authorized level of access. For example, for a certain logon ID and password, the system may reconstruct the form to include all Group A fields but only certain Group B fields. For example, the system may include fields 189 and 190 in the reconstructed file, but not fields 191 and 192.

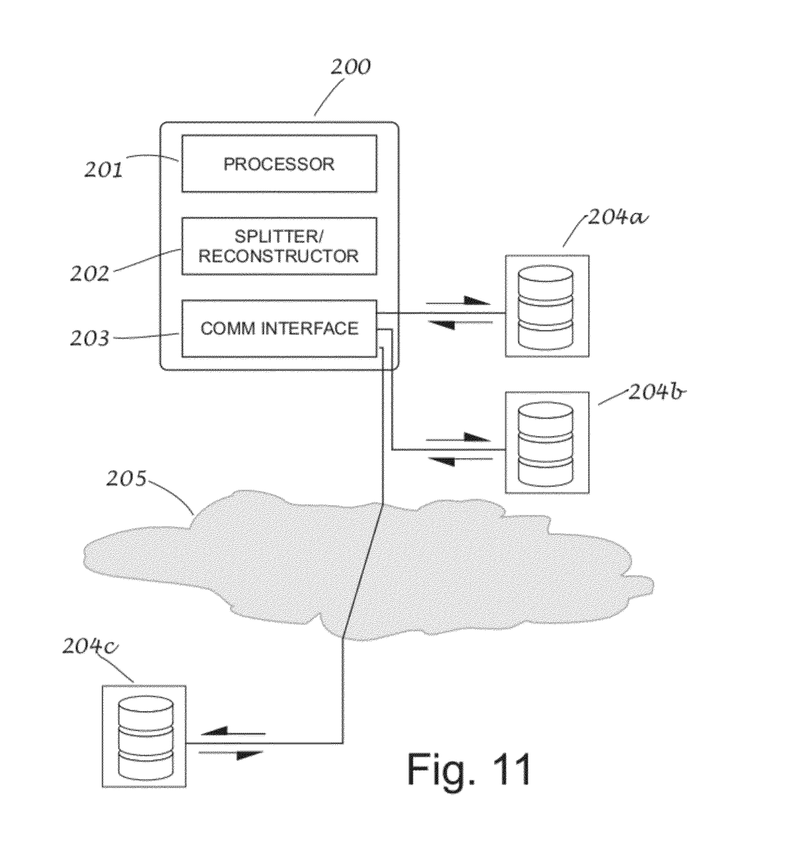

FIG. 11 shows an embodiment of a system configured according to the invention comprising a system 200 where a form such as in FIG. 10 is processed. The form may be initially filled on paper and then converted to a digital file or may be filled in electronic format. System 200, which may be part of the repository system or client system, comprises a processor 201 and a splitter/reconstructer 202 that can split a file, such as digital version of form 180 in FIG. 10. The splitter and reconstructor may be software programs that are configured to split or reassemble a file. The processor 201 uses communication interface 203 to store various segments of the split file, or sub-files, in one or more storage units such as 204a, 204b, and 204c. These storage units may be local to the system, remote or in a combination of such locations. The file may be split on the basis of the information that is being stored, such as for example, the various fields in file 180 in FIG. 10. Segments of files split in this manner could be viewed by whoever gains access to the system unless they are encrypted.

Alternatively, the splitter 202 may split the file according to an algorithm based on the bytes in each word in the file or the bits in each byte. For example, the file may be split such that the first byte of each word is separated from each word and stored at a different location from the rest of the word. In the same way, one or more bits in each or certain bytes may be split off and stored separately. For example, the 2^{nd} and 4^{th} bit could be split off from each byte and stored separately. The file could then be reconstructed by the system by reversing certain steps that occurred during the splitting process. In this manner, an unauthorized individual would require access to several or all segments of the file if the file is to be fully reconstructed. To improve the security of files, certain segments could be stored at a remote repository.

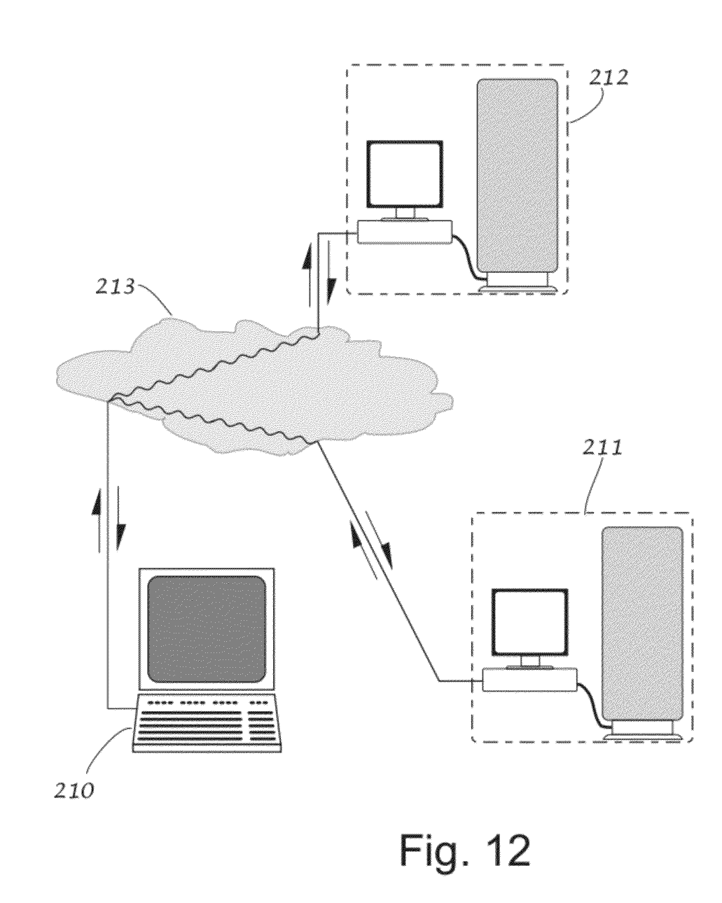

FIG. 12 shows an aspect of an embodiment configured according to the invention. System 210 is configured to split certain files and store one or more segments on systems 211 and 212. One of these systems may be a remote independent repository.

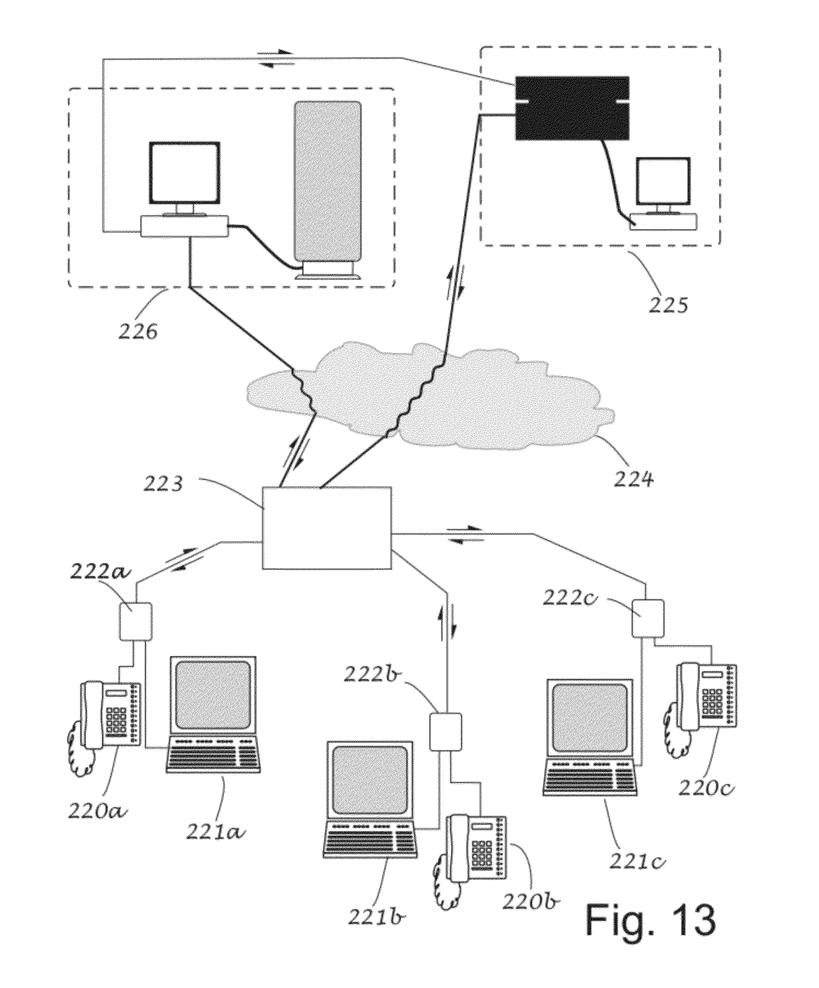

FIG. 13 shows an aspect of a further embodiment configured according to the invention. A client of a network accessible, electronic data storage facility 226 utilizes telephone 220a in a conference with parties using telephones 220b and 220c. Telephone 220a and computer 221a, preferably located at the same facility and location, are connected via junction box 222a, and network 224 to a telephone central office 223. Telephone and computer pairs 220b and 221b and 220c and 221c are also connected to the same or other central telephone office via junction boxes 222b and 222c, respectively. These telephone/computer pairs communicate with a conference facility 225 via a network 224, preferably the internet, and thus are used to participate in a conference call. The network accessible data storage facility 226 is preferably used to convert the voices of conference participants to text and using voice recognition to identify the speaker in real time and to notify one or more participants as to who is speaking by sending identifying information to the participants preferably via computers 221a-221c. Preferably, conference facilities 225 and data storage facility 226 are co-located. The identity of the participants in the conference call may be identified and preferably visually displayed, such as for example by displaying their names and/or pictures on a visual display. In addition, or alternatively, the identity of the speaking participant may be identified, preferably visually displayed, such as for example by displaying their name and/or picture on a visual display. Non-limiting examples of visual displays may be the screen on a smart phone, tablet computer, VoIP phone system or a computer monitor. Preferably, during setting up of the conference call, when participants call in, the voice of each participant is recorded and analyzed. This data may then be used to subsequently identify the speaker in real time. The repository system may also store an audio recording of the conference, the text transcript or both in a client folder.

The invention has been described in terms of functional principles and illustrations of specific embodiments. Embodiments described herein, including descriptions of the figures, are merely intended as exemplary, but the concept of the invention is not limited to these embodiments. The following claims are not limited to or by the described illustrative embodiments, figures, and stated objectives of the invention or the abstract. Furthermore, various presently unforeseen or unanticipated combinations of the disclosed embodiments, or their elements, or alternatives, variations or improvements which may become apparent to those of skill in the art are also intended to be encompassed by the following claims.

What is claimed is:

1. A method for storing information on a network accessible data repository system comprising:
providing a microprocessor based system having an information storage database having file storage;
providing limited access to said system to an independent first party;
storing information in at least one file on the system;
providing access to the first party files to the first party;
creating at least one metadata file on the system that comprises a historical record of the information stored in the at least one file; and
providing access to a second party different than the first party to at least some of the information in said metadata file as directed and limited by the first party.

2. The method in claim 1 wherein said historical record comprises at least one of the group consisting of when and by whom at least some information in the first party file was uploaded, downloaded, copied, viewed and modified.

3. The method of claim 1 further comprising allowing the second party access to at least some of the information in the at least one first party file as directed and limited by the first party.

4. The method in claim 1 wherein at least a portion of the information stored in the at least one file on the system is uploaded using the internet.

5. The method in claim 1 wherein at least a portion of the information stored in the at least one file on the system is obtained by the operator of the repository from various websites on the internet as directed by the first party.

6. The method in claim 1 further comprising providing a certificate identifying the date when information on the system existed, was uploaded, downloaded, copied, viewed or modified.

7. A method for tracking information available on the internet comprising:
receiving a request from an independent party to copy and store at least a portion of the content of at least one page from at least one specific website;
accessing the at least one specific website;
copying and storing at least a portion of the content of the at least one page of the at least one specific website; and
making the content available for viewing, copying or distributing.

8. The method in claim 7 wherein accessing, recording and storing of said content is repeated at a frequency requested by the independent party.

9. The method in claim 7 further comprising accessing the content of said at least one page of said website at a requested timing frequency and recording and storing the content only when the content has changed.

10. The method in claim 9 further comprising the making of the content available to others as specified by the independent party.

11. A method for facilitating a network accessible conference comprising:
establishing a communication link among three or more participants in a conference communication; and
using voice recognition to identify participant speaking in real time.

12. The method in claim 11 further comprising the use of speech recognition to convert speech of at least one participant to text.

13. The method in claim 12 further comprising storing the text in a client file on a network accessible data repository system that is independent of the conference participants.

14. The method in claim 11 further comprising transmitting the identity of the speaker to at least one of said participants.

15. The method in claim 14 wherein transmitting the identity of the speaker to at least one of said participants includes providing at least one of the speaker's name and picture onto a visual display that can be viewed in real time by at least one participant in the conference.

16. The method in claim 11 wherein at least two of said participants participate in said conference using the same speaker phone.
